(19) United States
(12) Patent Application Publication
(10) Pub. No.: US 2017/0149495 A1
(43) Pub. Date: May 25, 2017

(54) TRANSMITTING DEVICE, FAILURE DIAGNOSIS METHOD, AND COMMUNICATION SYSTEM

(71) Applicant: FUJITSU LIMITED, Kawasaki-shi (JP)

(72) Inventor: Hiroyuki Itoh, Kawasaki (JP)

(73) Assignee: FUJITSU LIMITED, Kawasaki-shi (JP)

(21) Appl. No.: 15/271,934

(22) Filed: Sep. 21, 2016

(30) Foreign Application Priority Data
Nov. 19, 2015 (JP) 2015-227119

(51) Int. Cl. H04B 10/03; H04B 10/60; H04B 10/50; H04B 10/079; H04B 10/40

(52) U.S. Cl. CPC H04B 10/03; H04B 10/0791; H04B 10/40; H04B 10/50; H04B 10/60

(57) ABSTRACT

A transmitting device that transmits light to another transmitting device, includes: a variable attenuator configured to attenuate intensity of light; a drive circuit configured to control an amount of attenuation of the light in the variable attenuator at given intervals; and a detector configured to detect a failure of the drive circuit based on whether or not the amount of attenuation of the light in the variable attenuator changes at the given intervals.

### CROSS-REFERENCE TO RELATED APPLICATION

This application is based upon and claims the benefit of priority of the prior Japanese Patent Application No. 2015-227119, filed on Nov. 19, 2015, the entire contents of which are incorporated herein by reference.

### FIELD

The embodiments discussed herein are related to a transmitting device, a failure diagnosis method, and a communication system.

### BACKGROUND

A transmitting device in an optical communication system is equipped with an optical amplifier in order to compensate for the transmission loss of an optical signal. The causes of the transmission loss include the kind of fiber, bending of the fiber between transmitting devices, the transmission distance, and so forth.

Related arts include Japanese Laid-open Patent Publication No. 5-66353 or Japanese Laid-open Patent Publication No. 2004-297790.

### SUMMARY

According to an aspect of the embodiment, a transmitting device that transmits light to another transmitting device, includes: a variable attenuator configured to attenuate intensity of light; a drive circuit configured to control an amount of attenuation of the light in the variable attenuator at given intervals; and a detector configured to detect a failure of the drive circuit based on whether or not the amount of attenuation of the light in the variable attenuator changes at the given intervals.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates one example of a configuration of a transmitting device;

FIG. 2 illustrates one example of functional configuration blocks of a monitoring-and-control unit;

FIG. 3 illustrates one example of information stored in an information storing unit;

FIG. 4 illustrates one example of failure diagnosis relating to control of an amount of attenuation;

FIG. 5 illustrates one example of transmission of light between transmitting devices;

FIG. 6 illustrates one example of a relationship between time (position) of transmission of light between transmitting devices and intensity per wavelength;

FIG. 7 illustrates one example of a configuration of a transmitting device;

FIG. 8 illustrates one example of a communication system using transmitting devices; and

FIG. 9 illustrates one example of an upper limit value and a lower limit value of a reception range and a reception level.

### DESCRIPTION OF EMBODIMENT

For example, an optical amplifier incorporated in a transmitting device includes a variable attenuator in order to change the gain according to the environment of transmission of an optical signal. The variable attenuator is used to control the gain of the optical amplifier in consideration of the influence of the transmission loss of the optical signal caused mainly by the transmission.

The control of the amount of attenuation in the attenuator includes a method of adjusting the amount of attenuation from detection results of detectors provided upstream and downstream of the attenuator for example. Furthermore, for example, a method is included in which information on an input level detected in an optical amplifier of an optical node device on a receiving side is transmitted to an optical node device on a transmitting side and the amount of attenuation of the variable attenuator in the optical node device is adjusted so that an adjustment in which the optical signal is received with given intensity is carried out.

For example, a failure of a drive circuit of the variable attenuator might not be immediately detected.

The amount of attenuation of the variable attenuator is designed in consideration of the transmission loss and so forth in advance. Therefore, the value of the amount of attenuation of the variable attenuator is not changed unless the transmission loss changes. If the transmission loss does not change, the amount of attenuation of the variable attenuator is fixedly managed.

For example, if a failure occurs in the drive circuit of the variable attenuator, the amount of attenuation of the variable attenuator becomes uncontrolled and thus the amount of attenuation becomes fixed without change.

Because the amount of attenuation is managed at a fixed value, it might not be discriminated whether the amount of attenuation does not change due to a failure of the drive circuit or the amount of attenuation is being managed at a fixed value.

For example, when the transmission loss changes, the gain of the optical amplifier changes according to the transmission loss. For example, if the drive circuit of the variable attenuator is in failure, the value of the amount of attenuation of the variable attenuator is not changed and thus the gain of the optical amplifier does not change. It might be not until such a situation occurs that the drive circuit turns out to be in failure.

Such a problem might occur in a component other than the variable attenuator included in the optical amplifier.

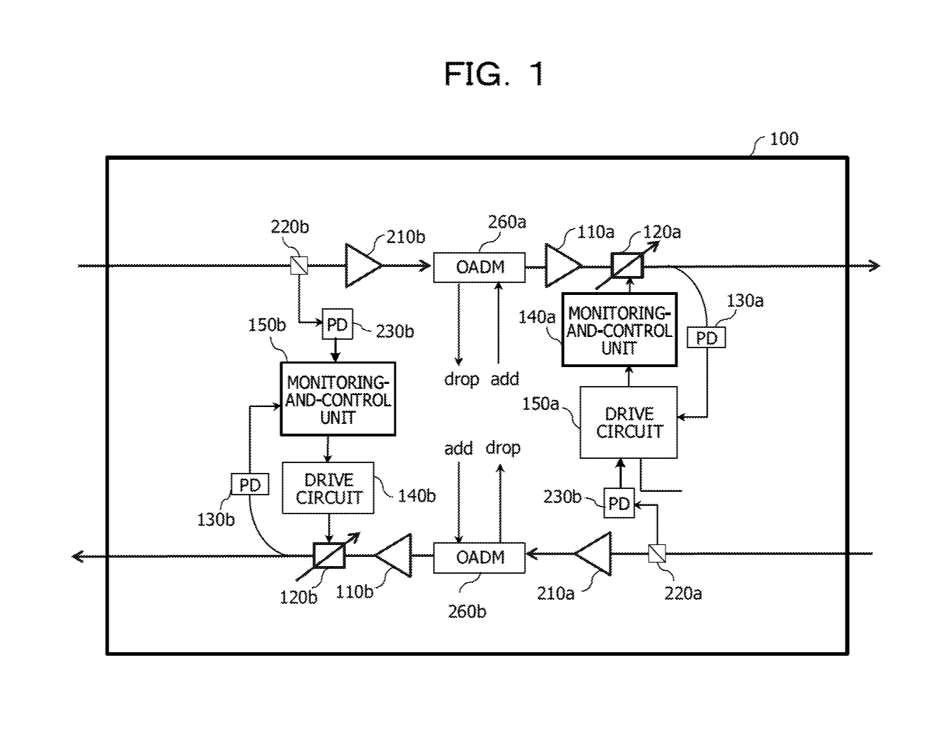

FIG. 1 illustrates one example of a configuration of a transmitting device.

A transmitting device 100 includes amplifiers (for transmission) 110a and 110b, variable attenuators 120a and 120b, photodiodes (PDs) 130a and 130b, drive circuits 140a and 140b, monitoring-and-control units 150a and 150b, amplifiers (for reception) 210a and 210b, branching units 220a and 220b, and PDs 230a and 230b. For example, when the constituent element is not discriminated, only the number might be described simply (for example, amplifier 110).

The amplifier 110 is for transmission and amplifies light input from an optical add drop multiplexer (OADM) 260. The amplifier 110 may be an optical amplifier such as an erbium-doped optical fiber amplifier (EDFA) or a Raman amplifier for example.

The variable attenuator 120 attenuates light output from the amplifier 110 based on control by a current (or voltage) from the drive circuit 140. In some cases, the variable attenuator 120 has a given amount of attenuation even in the case of the opened state (output from the drive circuit 140 is absent (zero voltage, zero current)).

The variable attenuator 120 adjusts the gain characteristic in amplification by the transmitting device 100 by attenuating the output of the amplifier 110.

The variable attenuator 120 adjusts the amount of attenuation based on information possessed by the monitoring-and-control unit 150.

The PD 130 detects light that is output from the variable attenuator 120 and is split, and notifies the monitoring-and-control unit 150 of the detection result.

The drive circuit 140 adjusts the amount of attenuation of the variable attenuator 120 based on control by the monitoring-and-control unit 150. The control of the amount of attenuation of the variable attenuator 120 in the drive circuit 140 may be carried out by the current (or voltage) applied to the variable attenuator 120 for example.

If the drive circuit 140 involves a failure, the current (or voltage) to the variable attenuator 120 is fixed at a given current (or voltage) and the amount of attenuation of the variable attenuator 120 becomes a fixed value. Thus, change in the amount of attenuation of the variable attenuator 120 is not carried out.

The monitoring-and-control unit 150 controls the drive circuit 140 and carries out failure detection of the drive circuit 140 based on the light detected in the PD 130. For example, the drive circuits 140a and 140b may be controlled by one monitoring-and-control unit 150.

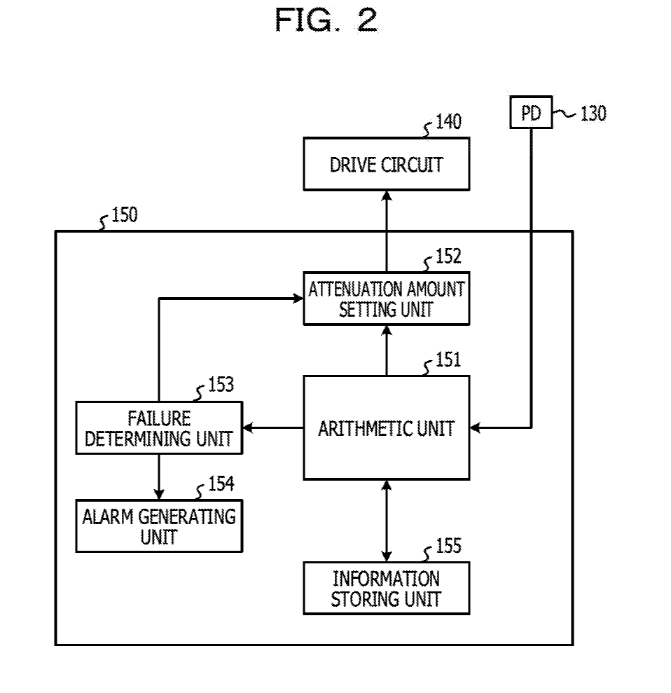

FIG. 2 illustrates one example of functional configuration blocks of a monitoring-and-control unit. The monitoring-and-control unit 150 includes an arithmetic unit 151, an attenuation amount setting unit 152, a failure determining unit 153, an alarm generating unit 154, and an information storing unit 155.

The arithmetic unit 151 calculates the amount of attenuation of light in the variable attenuator 120 from the detection result of the PD 130. For example, the arithmetic unit 151 calculates the amount of attenuation of light in the variable attenuator 120 from the changed amount of attenuation obtained based on the difference between the value of the amount of attenuation of the variable attenuator 120 before the change and the value detected in the PD 130 after the change.

The value before the change and the value after the change about the amount of attenuation of the variable attenuator 120 are values before and after the drive circuit 140 is operated and the amount of attenuation of the variable attenuator 120 is measured. The value of the amount of attenuation of the variable attenuator 120 before the change is stored in the information storing unit 155.

The PD 130 may be disposed also upstream of the variable attenuator 120, and the input and output levels of the variable attenuator 120 may be detected and calculation may be performed based on the difference between the detected levels. In this case, the amount of attenuation of the variable attenuator 120 may be calculated with only the measured values without taking information from the information storing unit 155.

The attenuation amount setting unit 152 sets the amount of attenuation in the variable attenuator 120 and notifies the drive circuit 140 of the set amount of attenuation. The attenuation amount setting unit 152 sets the amount to be changed of attenuation of the variable attenuator 120 based on information relating to the reception range of the amplifier on the receiving side, stored in the information storing unit 155 and the value of the amount of attenuation before the change.

The failure determining unit 153 compares the actual amount of attenuation of light actually attenuated in the variable attenuator 120, calculated in the arithmetic unit 151, and the amount of attenuation set in the attenuation amount setting unit 152 and determines a failure of the drive circuit 140 of the variable attenuator 120 to notify the alarm generating unit 154 of the determination result.

The failure of the drive circuit 140 of the variable attenuator 120 may refer to the state in which the amount of attenuation of the variable attenuator 120 is not changed based on the amount of attenuation set in the attenuation amount setting unit 152 (different from the change by the set amount of attenuation) due to the influence of that the current (or voltage) output from the drive circuit 140 becomes uncontrolled. In the determination of the failure, whether or not the drive circuit 140 is in the state of the above-described failure is determined.

It is also possible that the notification to the alarm generating unit 154 is carried out only when it is determined that the drive circuit 140 is in failure. In this case, the failure is indicated when the notification is carried out without determination of failure in the alarm generating unit 154. Thus, processing in the alarm generating unit 154 might decrease.

When receiving the notification from the failure determining unit 153, the alarm generating unit 154 determines whether or not the drive circuit 140 is in failure. In the case of failure, the alarm generating unit 154 indicates the failure so that the user can determine that the drive circuit 140 is in failure. For example, in the indication of failure, the user or administrator may be notified of the failure by another method such as e-mail. By being notified of the failure by the other method, the user might recognize the failure even when the user does not become aware of the indication (for example, when the user carries out control in a different room).

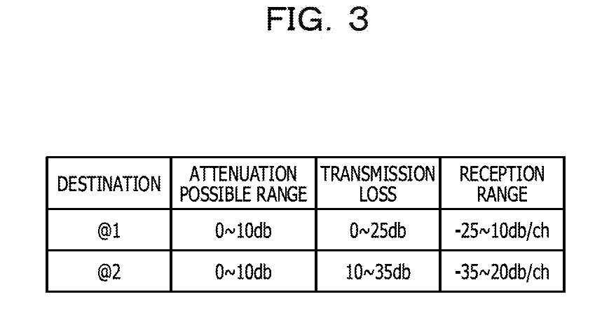

FIG. 3 illustrates one example of information stored in an information storing unit. As illustrated in FIG. 3, regarding each of the transmitting devices 100 of transmission destinations, the information storing unit 155 stores information on the attenuation possible range of the variable attenuator 120, the transmission loss, the reception range indicating the intensity range of light that can be received by the transmitting device 100 of the transmission destination, and so forth, for example.

The information storing unit 155 may be rewritable. For example, when information on change in the transmission loss or the like is received from the transmitting device 100 of a reception destination, the information storing unit 155 calculates the attenuation possible range by the arithmetic unit 151 according to the received information and rewrites the transmission loss and the attenuation possible range to store the latest information.

In the transmission loss in FIG. 3, ranges of the transmission loss are indicated. However, fixed values may be set if variation in the transmission loss is absent at given intervals. Destinations @1 and @2 in FIG. 3 represent one example of Short Reach section and Long Reach section, respectively.

The arithmetic unit 151, the attenuation amount setting unit 152, the failure determining unit 153, and the alarm generating unit 154 may be implemented by combining processing of a central processing unit (CPU), an integrated circuit such as an application specific integrated circuit (ASIC)/field programmable gate array (FPGA), a digital signal processor (DSP), and so forth. The information storing unit 155 may be a semiconductor memory element such as a random access memory (RAM), a read only memory (ROM), or a flash memory or a storing device such as hard disk or an optical disc for example.

In FIG. 1, the amplifier 210 is for reception and amplifies light received from another transmitting device 100. The amplifier 210 includes a reception range that is a given receivable range in order to suppress the deterioration of the signal-to-noise ratio that occurs when the reception intensity is low and is due to small difference between the signal and noise and a failure of parts that occurs when the reception intensity is high and is due to the intensity of light in the transmitting device 100. The amplifier 210 amplifies light regarding a signal with intensity in the reception range. The amplifier 210 may be an optical amplifier such as an EDFA or a Raman amplifier for example.

The branching unit 220 splits light received from another transmitting device 100. The branching unit 220 may include a splitter for example.

The PD 230 detects the light that is received by the transmitting device 100 and is split by the branching unit 220.

The OADM 260 carries out splitting of an optical signal on each wavelength basis and insertion of an optical signal to be transmitted to another transmitting device 100 on each wavelength basis, for one signal split by the branching unit 220.

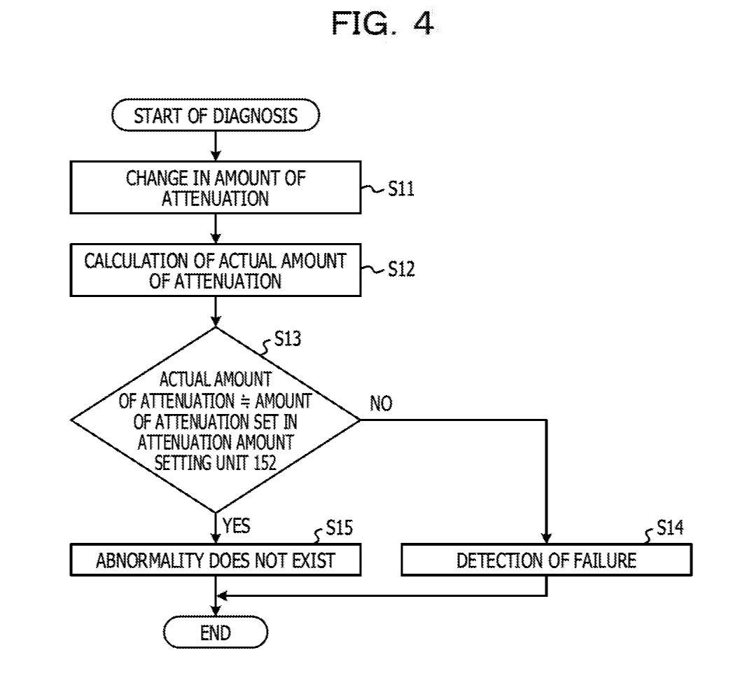

FIG. 4 illustrates one example of failure diagnosis relating to control of an amount of attenuation. In FIG. 4, failure diagnosis in control of the amount of attenuation of the variable attenuator 120 in the monitoring-and-control unit 150 is represented. The control of the amount of attenuation of the variable attenuator 120 may be carried out by controlling the current (or voltage) from the drive circuit 140 to the variable attenuator 120.

Upon the start of the failure diagnosis, the attenuation amount setting unit 152 notifies the drive circuit 140 of changing the amount of attenuation of the variable attenuator 120 (operation S11). The failure diagnosis may be started when a condition such as certain intervals, the time of mounting, or time elapse is satisfied for example.

The amount of change in the amount of attenuation may be so controlled that change by 0.5 dB or larger is made. For example, when the amount of change is small, it might not be recognized whether the change in the amount of attenuation is change due to signal fluctuation or the like or change due to control by the drive circuit 140.

For this reason, the determination may be accurately carried out by setting an allowable range defined in consideration of the change due to the signal fluctuation in order to recognize the change due to the control by the drive circuit 140. For example, change in the amount of attenuation by 0.5 dB or larger is desirable.

After the drive circuit 140 carries out control to change the amount of attenuation of the variable attenuator 120 to the amount of attenuation notified from the attenuation amount setting unit 152, the actual amount of attenuation of light actually attenuated in the variable attenuator 120 is calculated in the arithmetic unit 151 based on light detected in the PD 130 (operation S12).

Whether or not the actual amount of attenuation calculated in the arithmetic unit 151 is the amount of attenuation set in the attenuation amount setting unit 152 is examined (operation S13). Whether or not the actual amount of attenuation is the amount of attenuation set in the attenuation amount setting unit 152 may be determined based on whether a difference calculated based on the shift in the amount of attenuation between before and after the change in the amount of attenuation has a difference of a given value (the amount of change based on the values before and after the setting) or whether the amount of attenuation calculated from the amounts of attenuation before and after the change has a given amount of attenuation for example.

When the actual amount of attenuation is not the set amount of attenuation (operation S13: No), the alarm generating unit 154 signifies a failure (operation S14).

When the actual amount of attenuation is the set amount of attenuation (operation S13: Yes), it is determined that an abnormality in the control relating to the amount of attenuation of the variable attenuator 120 does not exist (operation S15), and the processing ends.

The processing illustrated in FIG. 4 may be repeatedly executed in accordance with a condition such as a certain interval. By the repetitive execution, a failure of the drive circuit 140 might be found in a time within the condition at whatever timing in operation the failure occurs. For example, after the operation S15, the amount of attenuation of the variable attenuator 120 may be returned to the amount of attenuation before the diagnosis. In this case, a notification is carried out from the attenuation amount setting unit 152 to the drive circuit 140 again for example.

When measurement is carried out again while the amount of attenuation is kept at the amount after the change, failure diagnosis may be carried out after the amount of attenuation is returned to the original amount of attenuation. By keeping the amount of attenuation at the amount after the change, the change in the amount of attenuation might decrease.

When the actual amount of attenuation is different from the amount of attenuation set in the attenuation amount setting unit 152 (operation S13: No), remeasurement may be carried out again by using different light in the operation S12 and failure diagnosis may be carried out by using the result of the remeasurement.

This is for reducing an erroneous diagnosis of the failure determination in e.g. the case in which the control of the variable attenuator 120 is incomplete immediately after change or the like.

The amount of attenuation may be changed in such a manner that the amount of attenuation with respect to light input to the variable attenuator 120 is decreased. For example, the amount of attenuation may be changed in such a manner that the reception intensity comes closer to the upper limit value of the reception range. Decreasing the amount of attenuation of the variable attenuator 120 might improve the signal-to-noise ratio of the whole signal.

The following operation may be carried out. For example, when the amount of attenuation is increased (when the amount of attenuation is changed in such a manner that the reception intensity is brought closer to the lower limit value of the reception range), the amount of attenuation is returned to the original amount after failure diagnosis. When the amount of attenuation is lowered (when the amount of attenuation is changed in such a manner that the reception intensity is brought closer to the upper limit value of the reception range), the amount of attenuation is not changed (not returned to the original amount) after failure diagnosis.

This might keep the amount of attenuation at the state in which the signal-to-noise ratio is high while carrying out failure diagnosis of the drive circuit 140.

As described above, the monitoring-and-control unit 150 of the transmitting device 100 carries out control over the drive circuit 140 to repeatedly change the amount of attenuation of the variable attenuator 120 at given intervals. Therefore, failure diagnosis of the drive circuit 140 is carried out on the amount of attenuation at the given intervals, and the situation in which the operation suddenly stops might be reduced.

For example, the monitoring-and-control unit 150 controls the drive circuit 140 to change the amount of attenuation of the variable attenuator 120 at certain intervals. Thereby, failure diagnosis at the certain intervals is carried out while the operation is carried out. For example, the amount of attenuation may be changed in consideration of the reception destination.

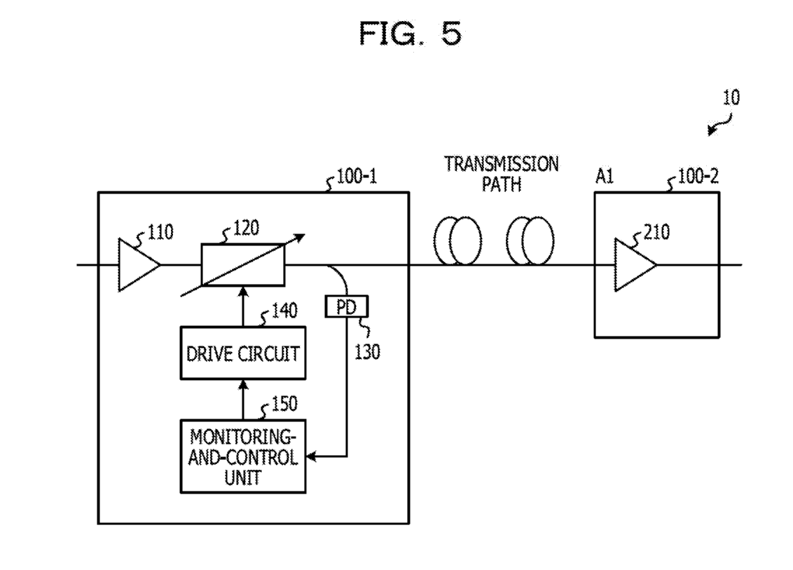

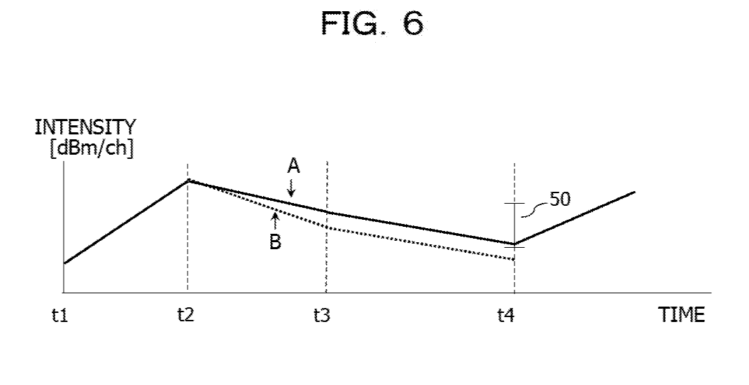

FIG. 5 illustrates one example of transmission of light between transmitting devices. In FIG. 5, one example of transmission of light from a transmitting device 100-1 to a transmitting device 100-2 is illustrated. FIG. 6 illustrates one example of a relationship between time (position) of transmission of light between transmitting devices and intensity per wavelength. In FIG. 6, one example of the time (position) in the transmission of light from the transmitting device 100-1 to the transmitting device 100-2 and the intensity per wavelength (dBm/ch) in a communication system 10 is represented.

The transmitting devices 100-1 and 100-2 of the communication system 10 of FIG. 5 may include the same configuration as or similar configuration to the transmitting device 100 of FIG. 1 and description similar to that of FIG. 1 might be omitted.

A solid line (A) after t2 described in FIG. 6 indicates an intensity profile before failure diagnosis of the drive circuit 140 and a dotted line (B) indicates an intensity profile after change in the amount of attenuation for the failure diagnosis. The intensity profile after the change in the amount of attenuation (dotted line (B)) represents one example in which the light intensity does not fall within a reception range 50 of the amplifier 210 for reception.

Time t1 represents the time when light is input to the amplifier 110 of the transmitting device 100-1.

Time t2 represents the time when the light is output from the amplifier 110 and is input to the variable attenuator 120.

Time t3 represents the time when the light is output from the variable attenuator 120 and is transmitted to the transmitting device 100-2.

Time t4 represents the time when the signal is received by the amplifier 210 of the transmitting device 100-2. At the time t4, the reception range 50 in which the amplifier 210 of the transmitting device 100-2 can receive the signal is described. In the operation of the communication system 10, the transmitting device 100-1 adjusts and operates the variable attenuator 120 so that the light intensity may fall within the reception range 50 of the amplifier 210 of the transmitting device 100-2 (for example, the state of the solid line (A)).

The time zone between t1 and t2, the time zone between t2 and t3, and the time zone between t3 and t4 represent amplification by the amplifier 110, attenuation by the variable attenuator 120, and attenuation due to the transmission loss, respectively. The transmission loss may be stable. The amount of attenuation of the variable attenuator 120 is the difference in the light intensity between the time t2 and the time t3.

For example, in the transmitting device 100-1, the amount of attenuation is changed from the solid line (A) in FIG. 6 to the dotted line (B) at certain timing for failure diagnosis. At this time, trouble might be caused in the normal operation if the variable attenuator 120 carries out attenuation due to which the light intensity does not fall within the set reception range 50 of the transmitting device 100-2 because of the change in the amount of attenuation in the transmitting device 100-1. For example, the change due to which the light intensity does not fall within the reception range 50 refers to that the light intensity does not fall within the reception range 50 in the transmitting device 100-2 due to the change in the amount of attenuation of the variable attenuator 120 (difference between the solid line (A) and the dotted line (B) at the time t3).

The above-described problem might occur in the transmitting device 100-2 due to the control of the variable attenuator 120 to provide an amount of change with which failure diagnosis is possible based on only information in the transmitting device 100-1 without consideration of information on the reception range 50 of the amplifier 210 of the transmitting device 100-2, the transmission loss, and so forth.

For this reason, the control of the drive circuit 140 is not carried out based on information of only the transmitting device 100-1 on the transmitting side and information on the receivable range of the amplifier 210 for reception in the transmitting device 100-2 on the receiving side might be desired. For example, information based on the reception intensity may be received from the transmitting device 100-2. The transmitting device 100-2 may feed back information based on the signal received from the transmitting device 100-1.

The transmitting device 100-1 may reflect the fed-back signal in the variable attenuator 120.

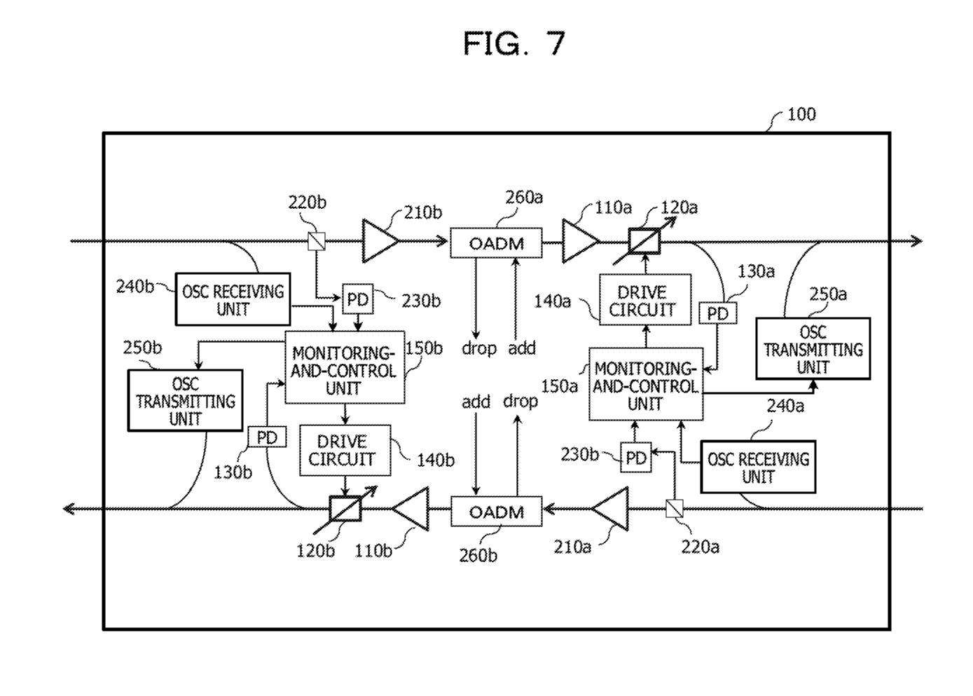

FIG. 7 illustrates one example of a configuration of a transmitting device. In FIG. 7, one example of a transmitting device 200 configured in consideration of feedback is illustrated. The transmitting device 200 includes amplifiers 110a and 110b, variable attenuators 120a and 120b, PDs 130a and 130b, drive circuits 140a and 140b, monitoring-and-control units 150a and 150b, amplifiers 210a and 210b, branching units 220a and 220b, PDs 230a and 230b, optical supervisory channel (OSC) receiving units 240a and 240b, OSC transmitting units 250a and 250b, and OADMs 260a and 260b. For example, when the constituent element is not discriminated, only the number might be described simply. The same constituent element as or similar constituent element to that in the transmitting device 100 illustrated in FIG. 1 is given the same numeral and description thereof might be omitted.

The OSC receiving unit 240 receives an OSC signal and notifies the monitoring-and-control unit 150 of information included in the received OSC signal.

The OSC transmitting unit 250 generates and transmits an OSC signal including information relating to the amount of attenuation in accordance with control by the monitoring-and-control unit 150. The OSC signal is inserted into a band having a given interval from a multiple signal that is normally managed.

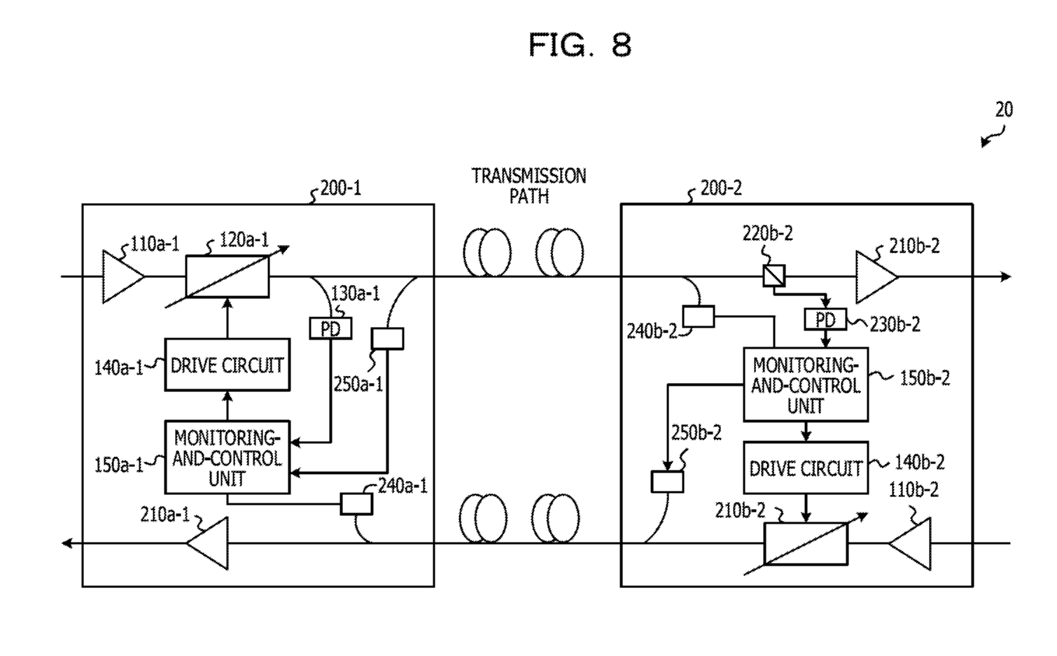

FIG. 8 illustrates one example of a communication system using transmitting devices. For example, the transmitting devices 200 are used in a communication system 20 illustrated in FIG. 8. The amounts of attenuation to which change is permitted for making diagnosis of failure of the drive circuit 140 of the variable attenuator 120 are calculated. Transmitting devices 200-1 and 200-2 illustrated in FIG. 8 may include the same configuration as or similar configuration to the transmitting device 200 illustrated in FIG. 7. However, only a given configuration may be described in FIG. 8 for convenience of explanation. In order to discriminate between the transmitting device 200-1 and the transmitting device 200-2, the monitoring-and-control unit 150 may be separately described as a monitoring-and-control unit 150a-1 and a monitoring-and-control unit 150b-2 for example.

When diagnosis of failure of the drive circuit 140 is started based on a condition such as certain timing, e.g. a certain interval or elapsed time, an OSC signal including request information to request information relating to the amounts of attenuation to which change is permitted is transmitted from an OSC transmitting unit 250a-1 to the transmitting device 200-2.

The transmitting device 200-2 receives the OSC signal including the request information from the transmitting device 200-1 by an OSC receiving unit 240b-2 and notifies the monitoring-and-control unit 150b-2 of the request information included in the received signal.

The signal transmitted from the transmitting device 200-1 is split by a branching unit 220b-2, is detected by a PD 230b-2 and then is notified to the monitoring-and-control unit 150b-2.

Based on the information requested by the OSC signal, the monitoring-and-control unit 150b-2 calculates the amounts of attenuation to which change is permitted and with which the light intensity falls within the reception range from information based on the intensity of the signal received by the PD 230b-2 and information based on the reception range of an amplifier 210b-2.

The monitoring-and-control unit 150b-2 notifies an OSC transmitting unit 250b-2 of the calculated amount of attenuation.

The OSC transmitting unit 250b-2 causes the information on the amount of attenuation notified from the monitoring-and-control unit 150b-2 to be included in an OSC signal and transmits the OSC signal to the transmitting device 200-1.

When an OSC receiving unit 240a-1 receives the information included in the OSC signal transmitted from the transmitting device 200-2, the transmitting device 200-1 notifies the monitoring-and-control unit 150a-1 of information relating to change in the amount of attenuation. The information relating to change in the amount of attenuation may be change in the transmission loss, the reception range of the transmitting device 200-2, and the amounts of attenuation to which change is permitted (lower limit value and upper limit value) for example.

The monitoring-and-control unit 150a-1 sets the amount of attenuation that changes in an attenuation amount setting unit 152a-1 (description in FIG. 8 is omitted) based on the notified information relating to change in the amount of attenuation and notifies the drive circuit 140a-1 of the set amount of attenuation.

In subsequent processing, diagnosis of failure may be carried out in accordance with the flowchart of FIG. 4.

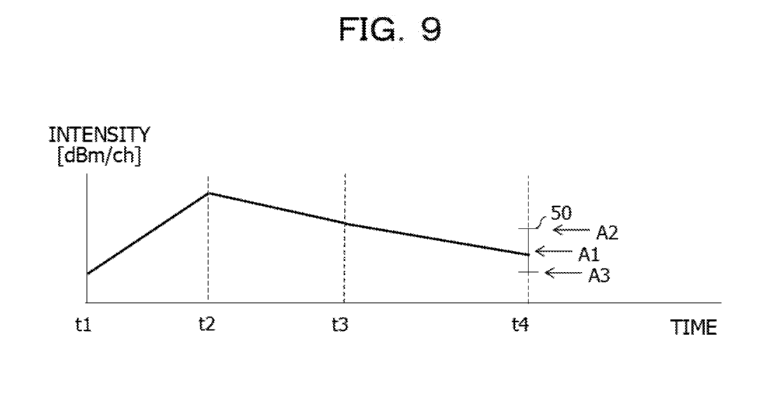

FIG. 9 illustrates one example of an upper limit value and a lower limit value of a reception range and a reception level. In FIG. 9, the relationship between the time (position) in transmission of light from the transmitting device 200-1 to the transmitting device 200-2 before change in the amount of attenuation and the intensity per wavelength (dBm/ch) is represented.

In FIG. 9, the intensity of light received by the amplifier 210b-2 may be A1, and the lower limit value of the reception range 50 may be A2 and the upper limit value may be A3.

As the amounts of attenuation to which change is permitted, the range in which the amount of attenuation can increase or decrease is calculated from the difference between A1 and A2 and the difference between A1 and A3 so that the light intensity may fall within the reception range 50.

The amount of calculation may be changed by calculating only one of the difference between A1 and A2 and the difference between A1 and A3.

The transmitting device 200-2 may decide and notify not the range of the amount of attenuation but the amount of attenuation to be changed, and thereby the setting in the transmitting device 200-1 may be simplified. In this case, the value with which the reception level falls within the range explained in the above is set.

As described above, the amount of attenuation with which the reception level falls within the reception range 50 of the amplifier 210b-2 of the transmitting device 200-2 of the transmission destination is calculated and the drive circuit 140a-1 is operated. The diagnosis of failure might be carried out without causing trouble in the normal operation.

The calculation of the amounts of attenuation to which change is permitted regarding a variable attenuator 120a-1 in the transmitting device 200-1 may be carried out in the monitoring-and-control unit 150b-2 in the transmitting device 200-2. For example, the calculation of the amount of attenuation may be carried out in the transmitting device 200-1.

For example, the procedure from transmission of an OSC signal to change in the amount of attenuation of the variable attenuator 120a-1 will be described by using the communication system 20 of FIG. 8.

In order to make diagnosis of failure of the drive circuit 140a-1 from the transmitting device 200-1, the OSC signal including request information to request information relating to the amounts of attenuation to which change is permitted is transmitted from the OSC transmitting unit 250a-1 to the transmitting device 200-2.

When receiving the OSC signal, the transmitting device 200-2 transmits, as an OSC signal, information used for the failure diagnosis regarding the reception intensity detected in the PD 230b-2 and the reception range of the amplifier 210b-2 from the OSC transmitting unit 250b-2 to the transmitting device 200-1. If information on the reception range is stored in an information storing unit 155a-1 of the transmitting device 200-1, the information relating to the reception range does not have to be transmitted.

When receiving the OSC signal by the OSC receiving unit 240a-1, from the information on the reception intensity and the reception range of an amplifier 210a-1 included in the OSC signal, the transmitting device 200-1 calculates, by the monitoring-and-control unit 150a-1, the amounts of attenuation to which change is permitted regarding the variable attenuator 120a-1 from the difference between the upper limit value (or lower limit value) of the reception range and the reception intensity. For example, the calculation may be carried out in an arithmetic unit 151a-1 (description in FIG. 8 is omitted) in the monitoring-and-control unit 150a-1.

The range of the amount of attenuation to which change is permitted or the amount of attenuation is calculated in the arithmetic unit 151a-1 and is notified to the attenuation amount setting unit 152a-1 in the monitoring-and-control unit 150a-1. The attenuation amount setting unit 152a-1 controls the drive circuit 140a-1 based on the notified information and changes the amount of attenuation of the variable attenuator 120a-1.

Subsequent processing may be processing similar to the processing illustrated in FIG. 4 and whether or not failure of the drive circuit 140a-1 exists is examined.

Due to that the amount of attenuation with which the light intensity falls within the reception range 50 of the amplifier 210b-2 of the transmitting device 200-2 of the transmission destination is calculated in the transmitting device 200-1 and the drive circuit 140a-1 is operated, the diagnosis of failure might be carried out without causing trouble in the normal operation.

For example, diagnosis of failure of the drive circuit 140 may be made in the operation. For example, failure diagnosis may be carried out before the operation.

The failure before the operation includes the case in which the drive circuit 140 receives an external factor and breaks down when the transmitting device 100 is being carried after being manufactured for example. In this case, at the manufacturing stage, the drive circuit 140 is not in failure and therefore the communication system is opened up without carrying out failure diagnosis. For example, if the communication system is opened up in the state in which the variable attenuator 120 is in the open state (output from the drive circuit 140 is absent), the drive circuit 140 remains in the failure state caused in the carrying (if the variable attenuator 120 is not in the open state, the drive circuit 140 operates to change the amount of attenuation of the variable attenuator 120 and thus the drive circuit 140 turns out to be in failure).

For example, because of the failure state before the communication system is opened up, it is desirable that the transmitting device 100 (or partial component) is replaced before the opening-up and then the opening-up is carried out.

Therefore, failure diagnosis of the drive circuit 140 may be carried out once before the communication system is opened up.

In the failure diagnosis of the drive circuit 140 before the opening-up of the communication system, the drive circuit 140 is operated when the transmission loss and so forth are measured in opening up the communication system, and the transmission loss and so forth are measured.

As described above, by operating the drive circuit 140 of the transmitting device 100 before the communication system is opened up, the transmitting device 100 (or partial component) is replaced before the start of the operation if the drive circuit 140 is in failure before the operation. Opening up the communication system while a failure remains might be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A transmitting device that transmits light to another transmitting device, comprising:
a variable attenuator configured to attenuate intensity of light;
a drive circuit configured to control an amount of attenuation of the light in the variable attenuator at given intervals; and
a detector configured to detect a failure of the drive circuit based on whether or not the amount of attenuation of the light in the variable attenuator changes at the given intervals.

2. The transmitting device according to claim 1, wherein,
the drive circuit controls the amount of attenuation in such a manner that reception intensity of light in the another transmitting device becomes intensity in a receivable range of the another transmitting device.

3. The transmitting device according to claim 2, wherein,
the drive circuit controls the amount of attenuation in such a manner that the reception intensity of light in the other transmitting device becomes closer to an upper limit value of the receivable range.

4. The transmitting device according to claim 1, further comprising:
a receiver configured to receive information relating to reception intensity of light from the another transmitting device,
wherein the drive circuit controls the amount of attenuation based on the information relating to the reception intensity of light.

5. The transmitting device according to claim 2, further comprising:
a memory configured to store an amount of transmission path loss until transmission to the another transmitting device and the receivable range,
wherein the drive circuit controls the amount of attenuation based on information stored in the memory.

6. The transmitting device according to claim 1, further comprising:
an amplifier configured to amplify light at a previous stage of the variable attenuator.

7. The transmitting device according to claim 1, further comprising:
a receiver configured to receive the light with intensity in a given range; and
a transmitter configured to transmit, to the another transmitting device, information relating to the amount of attenuation in a changeable range in the variable attenuator based on the intensity of the light received by the receiver.

8. A failure diagnosis method for a drive circuit of a variable attenuator, comprising:
driving, at given intervals, the drive circuit that controls an amount of attenuation of the variable attenuator that attenuates intensity of light; and
detecting a failure of the drive circuit based on whether or not the amount of attenuation in the variable attenuator changes at the given intervals.

9. The failure diagnosis method according to claim 8, wherein,
the amount of attenuation is controlled in such a manner that reception intensity of light in the another transmitting device becomes intensity in a receivable range of another transmitting device.

10. The failure diagnosis method according to claim 9, wherein,
the amount of attenuation is controlled in such a manner that the reception intensity of light in the another transmitting device becomes closer to an upper limit value of the receivable range.

11. The failure diagnosis method according to claim 8, further comprising:
receiving information relating to reception intensity of light from another transmitting device,
wherein the amount of attenuation is controlled based on the information relating to the reception intensity of light.

12. The failure diagnosis method according to claim 9, further comprising:
storing an amount of transmission path loss until transmission to the another transmitting device and the receivable range,
wherein the amount of attenuation is controlled based on information stored in the memory.

13. The failure diagnosis method according to claim 8, further comprising:
amplifying light at a previous stage of the variable attenuator.

14. The failure diagnosis method according to claim 8, further comprising:
receiving the light with intensity in a given range; and
transmitting, to another transmitting device, information relating to the amount of attenuation in a changeable range in the variable attenuator based on the intensity of received light.

15. A communication system that transmits light from a first transmitting device to a second transmitting device, wherein,
the first transmitting device includes:
a variable attenuator configured to attenuate intensity of light;
a drive circuit configured to control an amount of attenuation of the variable attenuator at given intervals; and
a detector configured to detect a failure of the drive circuit based on whether or not the amount of attenuation of the light in the variable attenuator changes at the given intervals,
wherein the second transmitting device includes:
a receiver configured to receive light transmitted from the first transmitting device; and
a transmitter configured to transmit information relating to intensity of received light to the first transmitting device,
wherein the drive circuit of the first transmitting device controls the amount of attenuation of the variable attenuator based on the information that is transmitted from the second transmitting device and relates to the intensity of the light.

16. The communication system according to claim 15, wherein,
the drive circuit controls the amount of attenuation in such a manner that reception intensity of light in the another transmitting device becomes intensity in a receivable range of the another transmitting device.

17. The communication system according to claim 16, wherein,
the drive circuit controls the amount of attenuation in such a manner that the reception intensity of light in the other transmitting device becomes closer to an upper limit value of the receivable range.
